(19) United States
(12) Patent Application Publication
(10) Pub. No.: US 2006/0060008 A1
(43) Pub. Date: Mar. 23, 2006

(54) Test device and method for roll weight capacity testing

(75) Inventors: Xiaokai Niu, Hartsville, SC (US); David E. Rhodes, Hartsville, SC (US); Jason Tillman Stephens, Hartsville, SC (US); Yiming Wang, Middleton, WI (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 10/947,861

(22) Filed: Sep. 23, 2004

(51) Int. Cl. B65H 63/04; G01L 5/10

(52) U.S. Cl. 73/865.9; 73/862.543; 242/912

(57) ABSTRACT

A test device includes a stationary web roll support assembly comprising a base and a pair of core supports spaced apart and affixed to the base with the core supports projecting upwardly from the base, the core supports structured and arranged to engage opposite ends of a core of a web roll so as to support the web roll. The test device also includes a movable weight load simulating assembly comprising a flexible belt having opposite ends, and a belt holder structured and arranged to secure the opposite ends of the belt to the belt holder with the belt forming a generally U-shaped loop about an outer surface of the web roll intermediate the opposite ends of the core. Movement of the belt holder away from the stationary web roll support assembly causes the belt to exert a load on the web roll, simulating weight load on the core and core supports.

### BACKGROUND OF THE INVENTION

The invention relates to winding cores for web rolls. The invention relates more particularly to a test device and testing method for assessing the weight capacity of a core.

Tubular winding cores are used for supporting rolls of web materials wound about the cores. Various web materials are commonly supplied in the form of relatively large rolls wound about cores. Such web materials can include paper, plastic film, metal foil, sheet metal, textile, and the like. The cores are often paperboard tubes, but can comprise other materials such as plastic, fiber-reinforced plastic, and others. Particularly in the case of paperboard cores, weight capacity of the cores is a significant issue. In a winding or unwinding process, the web roll is typically supported in the winding or unwinding machinery by engaging the core only at its opposite ends, such that the major part of the length of the core is suspended between the opposite ends. The ends can be engaged by chucks inserted into the ends of the core.

After completion of winding of a roll, it is standard industry practice at least in the case of film to prevent the wound material from contacting the ground or other surfaces that could damage the film material. Accordingly, during various phases of movement of the wound roll from the winding machinery, through handling, storage, shipping, all the way up to the ultimate usage of the roll, the roll is at all times supported by engaging the opposite ends of the core in various support structures. For instance, the ends of the core can be rested in cradles, which can comprise openings of various shapes (semi-circular, V-shaped) in end walls between which the roll is suspended. Alternatively, the roll can be supported between a pair of end walls that support end plugs that fit into the opposite ends of the core. Because most of the core length between the ends is unsupported, with very heavy rolls the core may be stressed to the point of failure. Alternatively, the supporting cradle or end wall/plug structures may be stressed to the failure point.

Accordingly, it would be desirable to be able to test cores and core-supporting structures to determine their weight-holding capacity. The testing advantageously should simulate as closely as possible the actual usage conditions.

### BRIEF SUMMARY OF THE INVENTION

The present invention addresses the above needs and achieves other advantages, by providing a testing device and method wherein the core of a web roll is supported by core supports in a manner substantially identical to that used in actual use, and a weight load simulating assembly is used to load the web roll so that the core and core supports are loaded in a manner closely simulating the weight of wound web material on the core and/or core supports in actual use. Either the core, or the core supports, or both, can be tested for strength in this manner.

A test device in accordance with one embodiment of the invention includes a stationary web roll support assembly comprising a base and a pair of core supports spaced apart and affixed to the base with the core supports projecting upwardly from the base, the core supports structured and arranged to engage opposite ends of a core of a web roll so as to support the web roll. The test device also includes a movable weight load simulating assembly comprising a flexible belt having opposite ends, and a belt holder structured and arranged to secure the opposite ends of the belt to the belt holder with the belt forming a generally U-shaped loop about an outer surface of the web roll intermediate the opposite ends of the core. Movement of the belt holder away from the stationary web roll support assembly causes the belt to exert a load on the web roll, simulating weight load on the core and core supports.

In one embodiment, the base is structured and arranged to alternatively support any of various types of core supports including stands with chucks, end walls with cradles, end walls with end plugs, and end walls with cradles and end plugs.

Advantageously, the base is structured and arranged to be affixed to a frame of a load testing machine, and the belt holder is structured and arranged to be affixed to a load cell of the load testing machine.

In the case where the core supports comprise stands and chucks mounted to the stands, the chucks are structured and arranged to engage an inner surface of the core at each end of the core so as to support the web roll.

Alternatively, the core supports can comprise generally plate-shaped end walls projecting perpendicularly from the base and parallel to each other, the end walls defining cradles structured and arranged to engage an outer surface of the core at each end thereof so as to support the web roll. As an alternative to cradles, the end walls can have end plugs structured and arranged to extend into the opposite ends of the core and engage an inner surface of the core at each end so as to support the web roll. Cradles may also be used in combination with end plugs that fit into the core ends for reinforcement of the core ends.

The belt holder in one embodiment includes an adjustment mechanism structured and arranged to adjust the length of the loop of the belt. It is also advantageous in some instances for the belt to comprise two or more separate belt segments arranged side-by-side for engaging different lengthwise portions of the web roll.

A method for testing roll weight capacity in accordance with the invention comprises the steps of supporting a web roll by engaging opposite ends of a core of the web roll with a pair of stationary core supports, looping a flexible belt about an outer surface of the web roll at a position intermediate the opposite ends of the core, and advancing the belt in a direction substantially perpendicular to a longitudinal axis of the core such that the belt exerts a load on the web roll simulating weight load on the core and core supports.

The method can further include the steps of measuring the amount of force exerted on the belt and thus on the web roll, and optionally measuring strain of the core and/or strain of the core supports with at least one strain gage. The method can entail gradually increasing the amount of force exerted on the belt until a failure of either the core or the core supports occurs, and recording a maximum amount of force at which the failure occurs. The amount of force exerted on the belt (and the strain of the core or core supports, if measured) can be recorded as functions of time.

As noted, the core supports can be affixed to a frame of a load testing machine, and the belt can be secured to a load cell of the load testing machine. The load cell is advanced to cause the belt to exert a load on the web roll.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a loading testing machine in which is mounted a test device in accordance with one embodiment of the invention, with the test device supporting a roll of web material;

FIG. 2 is a perspective view of the roll of web material in isolation;

FIG. 3 is an exploded perspective view of an assembly comprising a load cell of the load testing machine and the test device

FIG. 4 is a cross-sectional view through the belt holder of the test device, along line 4-4 in FIG. 3;

FIG. 5 is a cross-sectional view through the test device along line 5-5 in FIG. 3;

FIG. 6 is a perspective view of a test device in accordance with another embodiment of the invention;

FIG. 7 is a cross-sectional view through the test device along line 7-7 in FIG. 6;

FIG. 8 is a view similar to FIG. 7, showing yet another embodiment of the invention;

FIG. 9 depicts a further embodiment of the invention;

FIG. 10 is a perspective view of a test device in accordance with still another embodiment of the invention, employing arcuate cradles that engage only a portion of the circumference of a core;

FIG. 11 is a cross-sectional view along line 11-11 in FIG. 10; and

FIG. 12 is a view similar to FIG. 11, showing an alternative cradle geometry.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

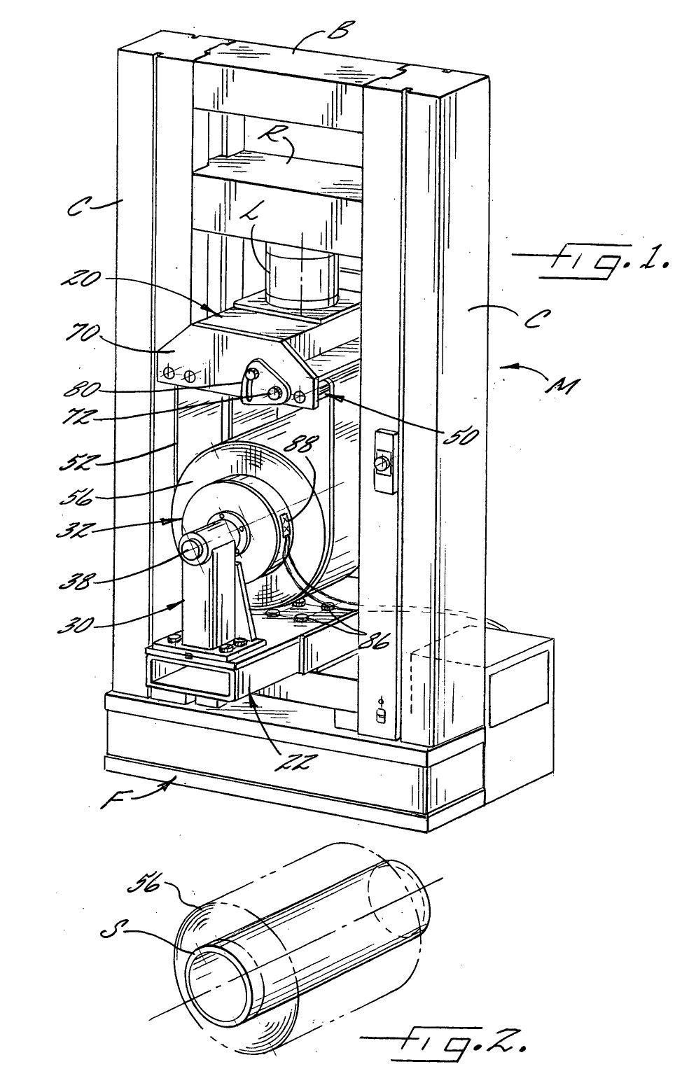

FIG. 1 depicts a test set-up for testing the weight capacity of a core. A test device 20 in accordance with one embodiment of the invention is shown mounted in a load testing machine M. The load testing machine comprises a frame formed by a bottom foundation F made up of beam elements or the like, having extremely high stiffness such that no substantial deformation of the foundation occurs under the loads exerted during testing. The frame also includes a pair of upright columns C affixed to the foundation and extending upwardly therefrom, with the columns being spaced apart and parallel to each other. An upper support beam B is connected between the upper ends of the columns. The columns are configured to engage a reciprocating ram R in a slidable fashion so that the ram can move upward and downward between the columns. Various configurations of the columns and ram and possible, the illustrated configuration merely being one example. A drive mechanism (not shown) is connected to the ram R for driving the ram upward or downward. The drive mechanism can be housed within the columns C and can comprise various types of devices such as hydraulic cylinders, screw drives, and the like. The testing machine also includes a load cell L mounted to the lower surface of the ram R for measuring tensile load exerted between the ram and the foundation F.

The test device 20 is mounted in the testing machine between the foundation F and the load cell L. With reference to FIGS. 1-5, the test device 20 includes a base 22 of beam and/or box type elements such that the base has a sufficiently high stiffness to prevent any substantial deformation of the base under the tensile loads exerted during testing. The base 22 has a generally flat and horizontal upper surface. A series of mounting apertures 24 of various configurations and arrangements extend through the upper surface of the base for mounting various configurations of core supporting structures atop the base, as further described below.

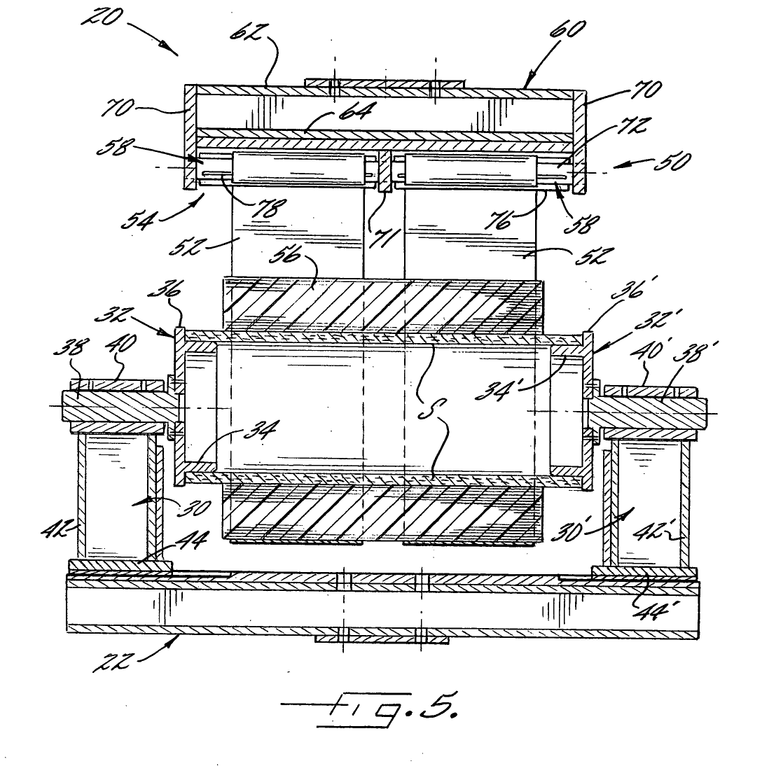

The test device 20 also includes a pair of core supports 30 and 30′ mounted atop the base 22. In the embodiment of FIGS. 1-5, the core supports are configured for replicating a usage environment wherein a core is supported by wind or unwind chucks inserted into the opposite ends of the core. Accordingly, each of the core supports 30, 30′ includes an associated chuck 32, 32′. Each chuck comprises a tubular section 34, 34′ configured to fit tightly into the open ends of a core test specimen S, and a disc member 36, 36′ affixed to one end of the tubular section 34, 34′ and of slightly larger diameter than the tubular section such that the disc members can abut the ends of the core test specimen when the tubular sections are fully inserted as shown in FIG. 5. A support shaft 38, 38′ is affixed to each disc member 36, 36′ on the opposite side of the disc member from the tubular section 34,34′, and extends perpendicularly from the disc member. A sleeve 40, 40′ closely surrounds each support shaft 38, 38′, and each sleeve is affixed to the upper end of a vertical support column or stand 42, 42′. The shafts 38, 38′ are rotatable within the sleeves 40, 40′. The lower end of each support column 42, 42′ is affixed to a mounting plate 44, 44′ that is attached by suitable fasteners to the upper surface of the base 22.

The test device 20 further includes a movable weight load simulating assembly 50. The weight load simulating assembly includes at least one flexible belt 52 having opposite ends secured in a belt holder 54, with the belt forming a generally U-shaped loop about an outer surface of a web roll 56 wound about the core test specimen S, intermediate the opposite ends of the core. In the illustrated embodiment, two belts 52 are employed, with each belt engaging a partial lengthwise portion of the web roll, but alternatively a single belt could be used. The belt holder 54 has a pair of belt-securing mechanisms 58 (only one shown in FIG. 4) for securing the opposite ends of each belt 52. The belt-securing mechanisms are mounted in a frame 60 of the belt holder.

The frame 60 includes a box member comprising an upper support plate 62, a lower support plate 64 vertically spaced below the upper support plate, and vertical plates 66 extending between the opposite longitudinal edges of the plates 62, 64. A bottom mounting plate 68 is disposed below the box member and affixed thereto. The mounting plate 68 is wider than the box member such that portions of the plate extend beyond the opposite longitudinal edges of the box member. Vertical mounting plates 70 are affixed to the opposite ends of the box member and mounting plate 68, and the plates 70 have portions that extend vertically downward beyond the plate 68. Midway between the two end plates 70, another mounting plate 71 is affixed to the plate 68 and extends downward therefrom, as shown in FIG. 5.

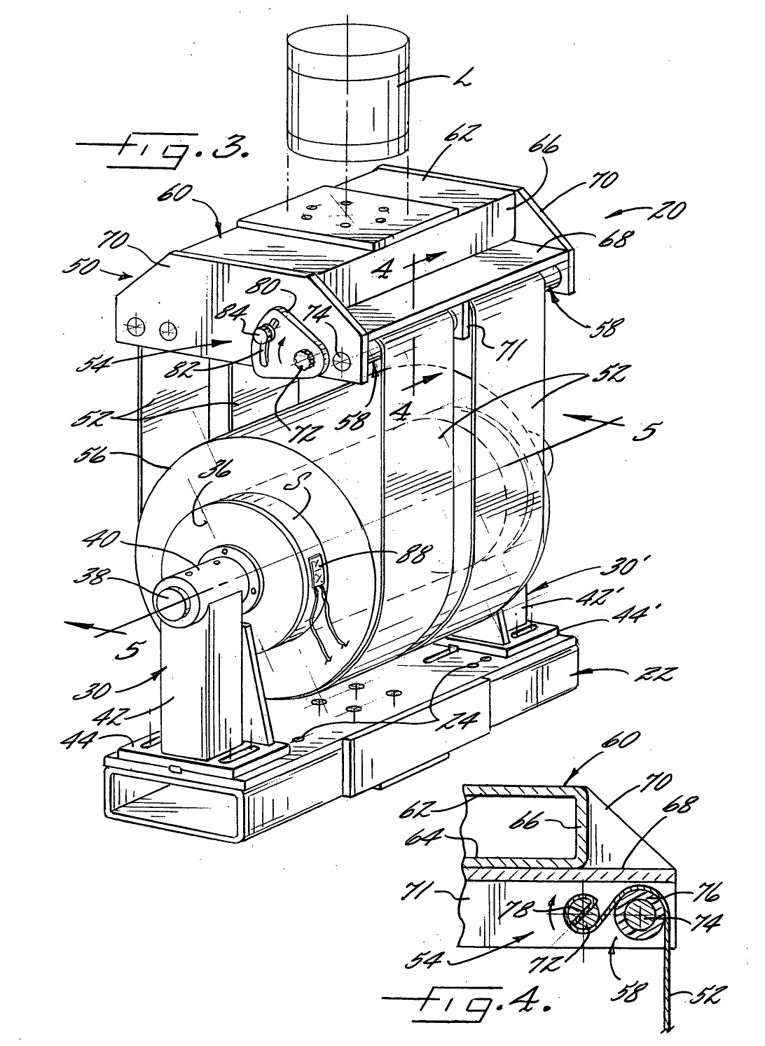

With reference to FIGS. 3 and 4, the belt-securing mechanism 58 for securing one end of each belt 52 comprises a tension bar 72 and a friction bar 74 mounted parallel to each other and extending between the end mounting plates 70 and through apertures in the middle mounting plate 71 such that the three mounting plates support the opposite ends and middle of each bar. The tension bar 72 is rotatable about its axis and includes a slot 78 into which the end of the belt 52 can be inserted, after which the tension bar is rotated about its axis preferably for a plurality of complete rotations to wrap and end portion of the belt about the bar so that the belt will not pull out of the slot 78. To prevent the tension bar from rotating during testing, an eccentric plate 80 (FIG. 3) is affixed to one end of the tension bar that protrudes through one end plate 70, and the plate 80 is secured by a fastener 84 extending through an elongate arcuate slot 82 in the plate 80 and into the end plate 70. The slot 82 allows the plate 80 to be rotated in one direction or the other by a limited amount for purposes of adjusting the length of the belt loop. The friction bar 74 has a high-friction sleeve or covering 76 about which the belt 52 wraps in opposite sense to the wrap about the tension bar 72, so that slippage of the belt is substantially prevented.

The opposite end of each belt 52 can be secured in the belt holder 54 by a mechanism substantially as described above, but without necessarily having the adjustability feature provided by the rotatable plate 80. Alternatively, the opposite end of each belt can be secured in the belt holder in any other suitable fashion allowing removal and replacement of the belt when broken or worn out.

In use, the base 22 of the test device is affixed by threaded fasteners 86 or the like to the foundation F of the testing machine M, and the belt holder 54 is affixed to the load cell L. A web roll 56 is mounted in the test device by placing the web roll into the loops of the belts 52 with one or both of the core supports 30, 30′ removed, and temporarily resting the web roll in the belts while fastening the removed core support(s) to the base 22. The chucks 32, 32′ are inserted into the opposite ends of the core specimen S before one or both of the core supports are affixed to the base 22. Once the core supports are affixed to the base, with the chucks engaged in the ends of the core, the belts 52 are adjusted to the correct length, if necessary, so that the belts snugly engage the outer surface of the web roll. The test can then proceed by operating the load testing machine to advance the ram R upwardly so that load is exerted on the web load by the belts, thereby simulating weight load on the core specimen S.

As known in the art, the load testing machine includes its own instrumentation, including the load cell L, for measuring the tensile force exerted between the ram R and the foundation F of the machine, which is equal to the load exerted on the web roll by the belts. The load can be recorded as a function of time. Generally, the ram R is advanced at a predetermined constant rate, and the load increases with time until a catastrophic failure occurs in the test specimen, at which point the load suddenly drops to zero or thereabouts. In the embodiment of FIGS. 1-5, the test specimen comprises the core of the web roll-i.e., the weak link in the chain connecting the load cell to the machine foundation is the core, such that the core will fail before any of the other components. The maximum load recorded just prior to failure represents the ultimate strength of the core.

Other parameters of interest can be measured and recorded in addition to the load exerted on the core versus time. For instance, one or more strain gages 88 can be attached to the core specimen S for measuring strain in the core at one or more locations, which also can be recorded as a function of time and can be correlated with the measured load.

The test device in accordance with the invention can be used to test more than just core strength. As previously noted, there are times during temporary storage and transportation of web rolls when the rolls are rested in cradles that support the opposite ends of the cores or mounted between end walls having end plugs that fits into the ends of the cores to support the rolls. It may be desired to test the strength of the cradle, end wall, and/or end plug structures. To do so, the chain of components connecting the machine ram to the machine foundation must be such that the component being tested is the weak link. Thus, for example, if the cradles are to be tested for strength, then it must be assured that the core does not fail before the cradles. This can be assured by using a special thick-walled core of great strength.

FIGS. 6 and 7 depict a test device 120 in accordance with an embodiment of the invention for testing end wall and cradle strength. The test device is in most respects identical to the previously described test device 20, differing only in the configuration of the core supports that support the web roll in the device. In this embodiment, the web roll is supported by a pair of core supports 130, 130′ that include end wall/cradle structures. Each core support comprises a vertical support plate 132, 132′ affixed atop a horizontal mounting plate 134, 134′ that is bolted or otherwise affixed to the base 22 of the test device. The mounting plates have a square or rectangular opening 136 for receiving a similarly shaped end wall 138 that fits closely within the opening. Releasable fasteners 139 hold the end wall in the opening in the horizontal direction but do not restrain it in the vertical direction. A circular hole extends through each end wall 138, having a diameter slightly greater than the outside diameter of the web roll core, the holes in the end walls thus forming cradles 140 in which the ends of the core rest to support the web roll (e.g., during temporary storage of the roll after winding). Thus, in this embodiment, as increasing load is exerted on the web roll by the belts 52, the load on the end walls 138 defining the cradles 140 progressively increases until a failure occurs in one or both of the end walls. Load can be recorded as a function of time, and if desired the end walls can be instrumented with strain gages to record strain versus time and/or load.

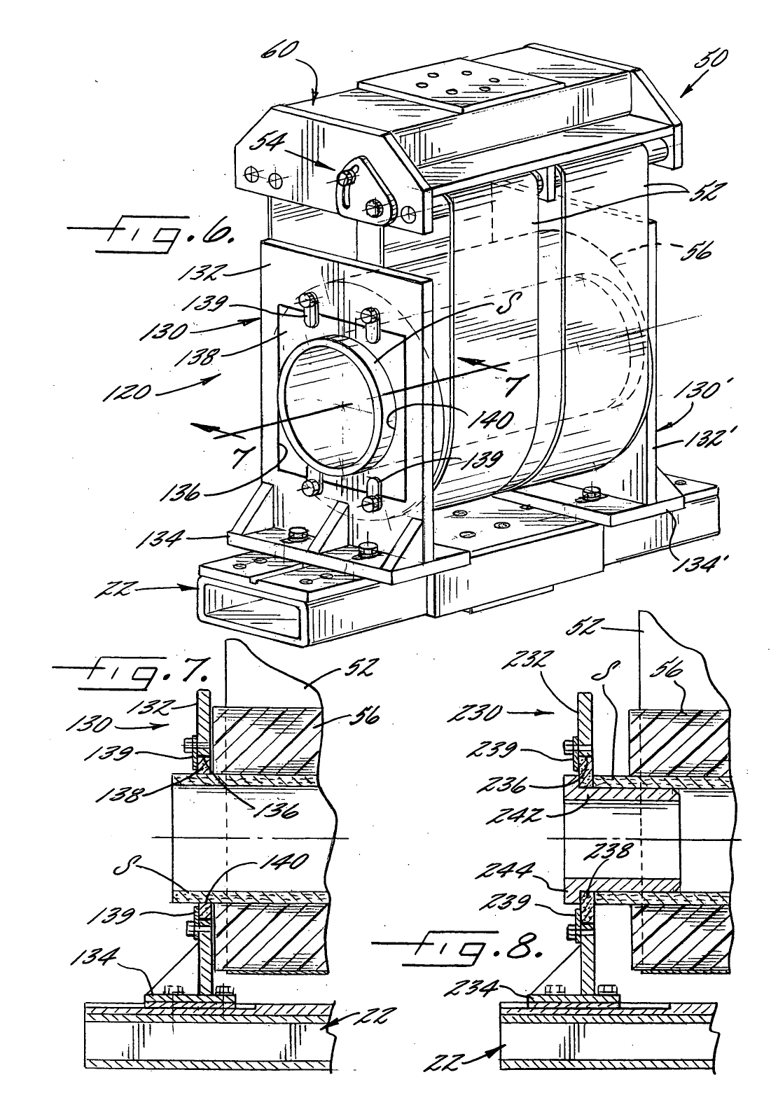

FIG. 8 depicts another embodiment wherein the core supports are configured for testing end plug strength. A core support 230 is shown, comprising a vertical support plate 232 affixed to a horizontal mounting plate 234 and having an opening 236, similar to the previously described core support 130. Within the opening 236, an end wall 238 is mounted and restrained in the horizontal direction by releasable fasteners 239. The end wall supports an end plug 242 having an outside diameter slightly smaller than the inside diameter of the web roll core, and the end plug fits into the end of the core to support the web roll. The tubular portion of the end plug has sufficient length to extend partially beneath the wound web roll 56 on the core. The end plug has a radial flange 244 that abuts the end of the core when the plug is fully inserted. Thus, in this embodiment, as increasing load is exerted on the web roll by the belts 52, the load on the end plugs 242 progressively increases until a failure occurs in one or both of the end plugs. Load can be recorded as a function of time, and if desired the end plugs can be instrumented with strain gages to record strain versus time and/or load. To ensure that the end plug is the first component to fail, a special thick-walled core can be used, and the end walls 238 can be made of a strong material such as metal, medium-density fiber board (MDF), or other suitable material.

FIG. 9 shows an embodiment similar to FIG. 7. In this embodiment, the core support 330 includes an end wall/cradle structure. The core support comprises a vertical support plate 332 affixed atop a horizontal mounting plate 334 that is bolted or otherwise affixed to the base 22 of the test device. The mounting plate has a square or rectangular opening 336 for receiving a similarly shaped end wall 338 that fits closely within the opening. Releasable fasteners 339 hold the end wall in the opening in the horizontal direction but do not restrain it in the vertical direction. A circular hole extends through each end wall 338, having a diameter slightly greater than the outside diameter of the web roll core, the hole in the end walls thus forming a cradle 340 in which the end of the core rests to support the web roll (e.g., during temporary storage of the roll after winding). Unlike the FIG. 7 embodiment, the core support further includes a core plug 342, similar to the plug described in connection with FIG. 8, for reinforcing the end of the core. The core plug includes a radial flange 344 that abuts the end of the core when the plug is fully inserted.

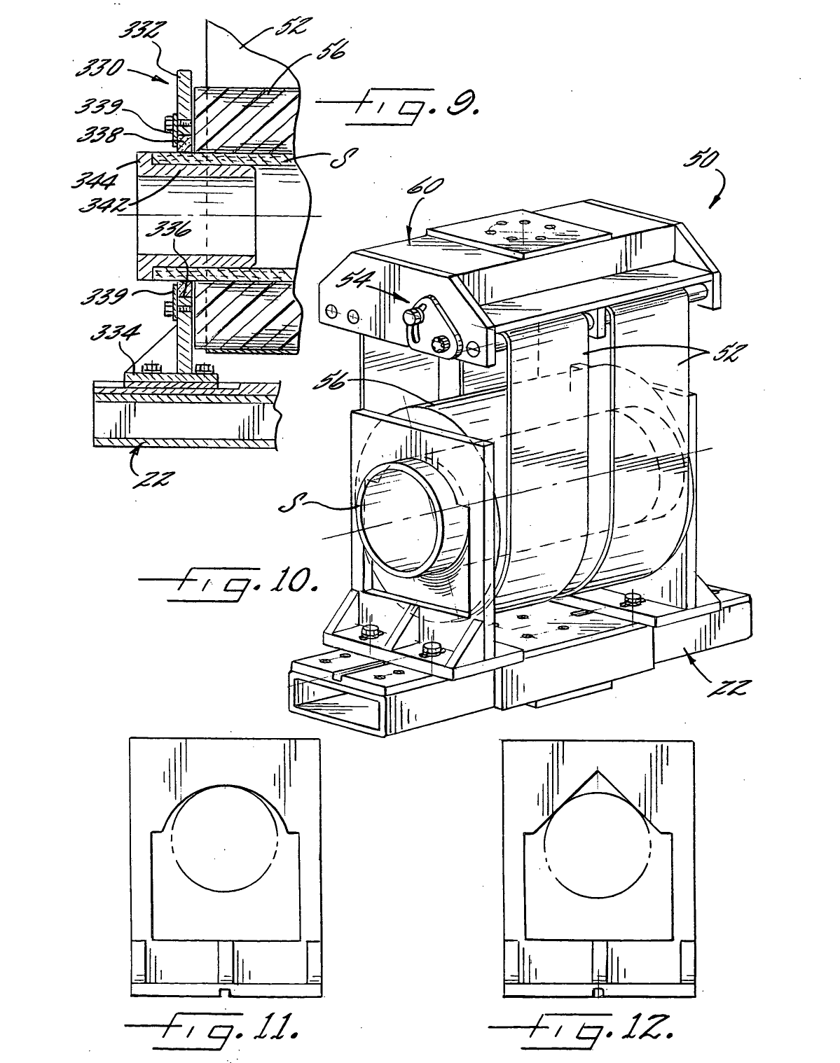

In some cases, web rolls are supported in cradles that are configured as semi-circular or arcuate, or V-shaped, structures that engage only a part of the circumference of the core ends resting in the cradles. FIGS. 10 and 11 show an embodiment of the invention for testing core supports that include arcuate cradles. The testing device of FIG. 10 has core supports 430, 430′ respectively comprising a vertical support plate 432, 432′ affixed atop a horizontal mounting plate 434, 434′ that is bolted or otherwise affixed to the base 22 of the test device. With reference to FIG. 11, the mounting plates have openings that define cradles 440 in which the ends of the core rest to support the web roll (e.g., during temporary storage of the roll after winding). As shown, each cradle 440 has an arcuate shape whose radius of curvature is greater than the radius of the core, such that the cradle engages only a portion of the circumference of the core.

FIG. 12 depicts an embodiment similar to that of FIG. 11, except that the core support 530 of FIG. 12 defines a cradle 540 of V-shaped configuration. It should be apparent that the invention is not limited to any particular configuration of cradle, but is capable of simulating or duplicating any cradle configuration of interest.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A test device for simulating weight load on a web roll core and core support system that supports the web roll via engagement of opposite ends of the core, the test device comprising:
a stationary web roll support assembly comprising:
a base; and
a pair of core supports spaced apart and affixed to the base with the core supports projecting upwardly from the base, the core supports structured and arranged to engage opposite ends of a core of a web roll so as to support the web roll; and
a movable weight load simulating assembly comprising:
a flexible belt having opposite ends; and
a belt holder structured and arranged to secure the opposite ends of the belt to the belt holder with the belt forming a generally U-shaped loop about an outer surface of the web roll intermediate the opposite ends of the core, whereby movement of the belt holder away from the stationary web roll support assembly causes the belt to exert a load on the web roll, simulating weight load on the core and core supports.

2. The test device of claim 1, wherein the base is structured and arranged to be affixed to a frame of a load testing machine, and the belt holder is structured and arranged to be affixed to a load cell of the load testing machine.

3. The test device of claim 1, wherein the core supports comprise stands and chucks mounted to the stands, the chucks structured and arranged to engage an inner surface of the core at each end of the core so as to support the web roll.

4. The test device of claim 1, wherein the core supports comprise generally plate-shaped end walls projecting perpendicularly from the base and parallel to each other, the end walls defining cradles structured and arranged to engage an outer surface of the core at each end thereof so as to support the web roll.

5. The test device of claim 4, wherein each core support includes a vertical support plate having an opening therethrough and means for releasably mounting one of the end walls in the opening.

6. The test device of claim 1, wherein the core supports comprise generally plate-shaped end walls projecting perpendicularly from the base and parallel to each other, the end walls having end plugs structured and arranged to extend into the opposite ends of the core and engage an inner surface of the core at each end so as to support the web roll.

7. The test device of claim 6, wherein each core support includes a vertical support plate having an opening therethrough and means for releasably mounting one of the end walls in the opening.

8. The test device of claim 1, wherein the base is structured and arranged to alternatively support stands with chucks, end walls with cradles, and end walls with end plugs.

9. The test device of claim 1, wherein the belt holder includes an adjustment mechanism structured and arranged to adjust the length of the loop of the belt.

10. The test device of claim 1, wherein the belt holder includes a belt-securing mechanism including a tension bar about which an end of the belt is wrapped and a friction bar about which the belt extends to resist slippage of the belt.

11. The test device of claim 1, wherein the belt comprises two belt segments each having opposite ends secured in the belt holder so as to form two side-by-side U-shaped loops of the belt segments for looping about different lengthwise portions of the web roll.

12. A method for testing roll weight capacity of a web roll support system, the method comprising the steps of:
supporting a web roll by engaging opposite ends of a core of the web roll with a pair of stationary core supports;
looping a flexible belt about an outer surface of the web roll at a position intermediate the opposite ends of the core; and
advancing the belt in a direction substantially perpendicular to a longitudinal axis of the core such that the belt exerts a load on the web roll simulating weight load on the core and core supports.

13. The method of claim 12, further comprising the step of measuring the amount of force exerted on the belt and thus on the web roll.

14. The method of claim 13, further comprising the step of measuring strain of at least one of the core and core supports with at least one strain gage.

15. The method of claim 13, further comprising the step of gradually increasing the amount of force exerted on the belt until a failure of one of the core and the core supports occurs, and recording a maximum amount of force at which said failure occurs.

16. The method of claim 15, further comprising the step of measuring strain of the core using at least one strain gage during the step of gradually increasing the amount of force.

17. The method of claim 16, wherein the amount of force exerted on the belt and the strain of the core are recorded as functions of time.

18. The method of claim 12, wherein the step of supporting the web roll comprises inserting a chuck into each end of the core, the chucks engaging an inner surface of the core at each end.

19. The method of claim 12, wherein the step of supporting the web roll comprises inserting an end plug into each end of the core, the end plugs engaging an inner surface of the core at each end.

20. The method of claim 12, wherein the step of supporting the web roll comprises supporting the opposite ends of the core in a pair of cradles, the cradles engaging an outer surface of the core at each end.

21. The method of claim 12, further comprising the steps of affixing the core supports to a frame of a load testing machine, and affixing the belt to a load cell of the load testing machine, and wherein the step of advancing the belt comprises advancing the load cell.

22. The method of claim 21, further comprising the step of using the load cell to measure the amount of force exerted on the belt and thus on the web roll.

23. The method of claim 22, further comprising the step of gradually increasing the amount of force exerted on the belt until a failure of one of the core and the core supports occurs, and recording a maximum amount of force at which said failure occurs.

24. The method of claim 23, wherein the amount of force exerted on the belt is recorded as a function of time.

25. The method of claim 12, wherein the core is structured and arranged to be the first component of the web roll support system to fail as load is increased.

26. The method of claim 12, wherein the core supports are structured and arranged to be the first components of the web roll support system to fail as load is increased.
